(19) United States
(12) Patent Application Publication
(10) Pub. No.: US 2024/0061242 A1
(43) Pub. Date: Feb. 22, 2024

(54) DISPLAY DEVICE

(71) Applicant: Japan Display Inc., Tokyo (JP)

(72) Inventors: Yuji MAEDE, Tokyo (JP); Yasuhiro TAKAHASHI, Tokyo (JP)

(73) Assignee: Japan Display Inc., Tokyo (JP)

(21) Appl. No.: 18/451,126

(22) Filed: Aug. 17, 2023

(30) Foreign Application Priority Data
Aug. 19, 2022 (JP) 2022-131124

(51) Int. Cl. G02B 27/01

(52) U.S. Cl. CPC G02B 27/0103

(57) ABSTRACT

According to one embodiment, a display device includes an illumination device which emits illumination light, a display panel which modulates the illumination light and emits image light, a holographic optical element which reflects the image light emitted from the display panel, and a concave mirror which reflects the image light reflected by the holographic optical element, wherein when the image light reflected by the concave mirror enters a projection member, a virtual image is projected, and the holographic optical element reflects light incident at a specific angle of incidence on a Bragg reflection surface and transmits the light incident at an angle of incidence different from the specific angle of incidence.

### CROSS-REFERENCE TO RELATED APPLICATIONS

This application is based upon and claims the benefit of priority from Japanese Patent Application No. 2022-131124, filed Aug. 19, 2022, the entire contents of which are incorporated herein by reference.

### FIELD

Embodiments described herein relate generally to a display device.

### BACKGROUND

An optical system for observing virtual images using holograms has been developed.

### BRIEF DESCRIPTION OF THE DRAWINGS

FIG. 1 is a diagram showing a basic structure of a display device according to an embodiment.

FIG. 2 is a diagram showing a head-up display installed in a vehicle.

FIG. 3 is a diagram showing a positional relationship between a virtual image and a windshield.

FIG. 4 is a diagram showing a part of the display device of the embodiment.

FIG. 5 is a diagram schematically showing a configuration example of the display device of the embodiment.

FIG. 6 is an enlarged view of a part of the illustration of FIG. 5.

FIG. 7 is a diagram showing the positional relationship between a virtual image formed using a holographic optical element of the embodiment and a windshield.

FIG. 8 is a diagram showing a configuration example of the display device of the embodiment.

FIG. 9 is a diagram showing a configuration example of the display device of the embodiment.

FIG. 10 is an enlarged view of a part of the illustration of FIG. 9.

FIG. 11 is a diagram showing a head-up display of this configuration example installed in a vehicle.

FIG. 12 is a diagram showing a configuration example of a display device of an embodiment.

### DETAILED DESCRIPTION

In general, according to one embodiment, a display device comprises
an illumination device which emits illumination light;
a display panel which modulates the illumination light and emits image light;
a holographic optical element which reflects the image light emitted from the display panel; and
a concave mirror which reflects the image light reflected by the holographic optical element, wherein
when the image light reflected by the concave mirror enters a projection member, a virtual image is projected, and
the holographic optical element reflects light incident at a specific angle of incidence on a Bragg reflection surface and transmits the light incident at an angle of incidence different from the specific angle of incidence.

An object of the present embodiment is to provide a display device of a projection system using a holographic optical element, which can improve the efficiency in utilization of light.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. The first direction X, second direction Y and third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the electronic device on a tip side of the arrow in the third direction Z. Here, viewing from this observation position toward the X-Y plane defined by the first direction X and the second direction Y is referred to as plan view. Viewing a cross-section of the electronic device in the X-Z plane defined by the first direction X and the third direction Z or in the Y-Z plane defined by the second direction Y and the third direction Z is referred to as cross-sectional view.

### Embodiment

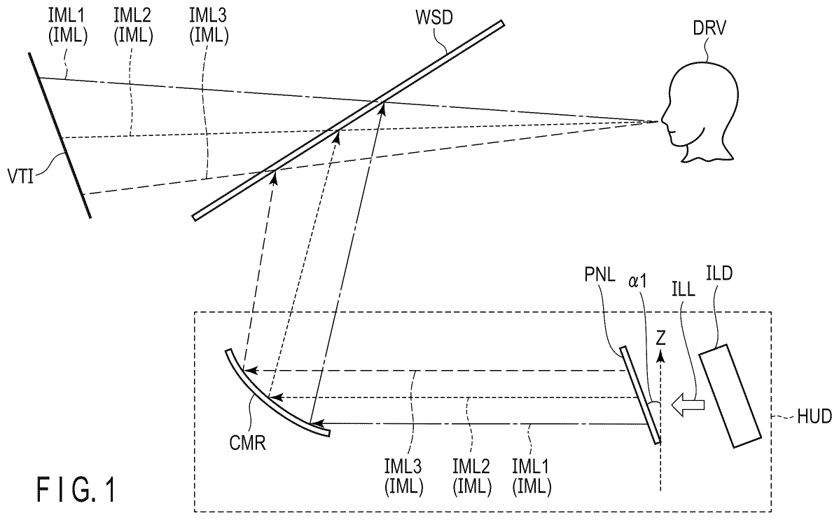

FIG. 1 is a diagram showing a basic configuration of a display device of an embodiment. The display device is a display device for projecting images, mainly, on a windshield WSD of a vehicle, that is, an in-vehicle display device. More specifically, the display device of the embodiment is, for example, an in-vehicle head-up display (HUD).

The head-up display HUD shown in FIG. 1 comprises an illumination device ILD, a display panel PNL and a concave mirror CMR. The illumination device ILD comprises a plurality of light source elements and illuminates the display panel PNL. Light emitted from the illumination device ILD is referred to as illumination light ILL. The illumination light ILL is emitted to the display panel PNL. The display panel PNL is inclined at an angle α1 with respect to the third direction Z. The illumination device ILD is similarly inclined. With this configuration, the illumination device ILD and the display panel PNL are arranged in parallel with each other.

The display panel PNL of this embodiment is a transmissive liquid crystal display panel. Light emitted from the display panel PNL is referred to as image light IML. The display panel PNL is an optical modulating element that modulates the illumination light ILL from the illumination device ILD and emits the image light IML. Note that the display panel PNL is not limited to a transmissive type, but may as well be a reflective type liquid crystal display panel.

Alternatively, the display panel PNL may as well be a display device that uses organic electroluminescence (EL), that is, the so-called organic light emitting device (OLED). Further, alternatively, it may as well be a display panel comprising a self-luminous light-emitting device such as a micro-LED or mini-LED.

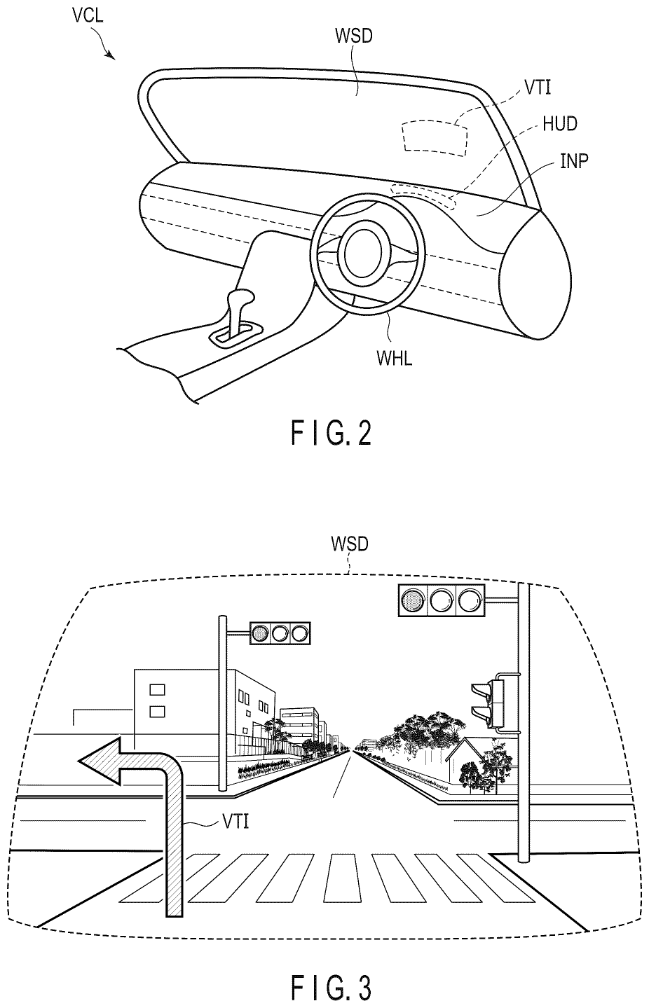

Note that as described above, when images are projected onto an in-vehicle windshield WSD by a head-up display HUD, the head-up display HUD needs to be installed in a vehicle VCL, as shown in FIG. 2.

FIG. 2 is a diagram showing a head-up display installed in a vehicle. The head-up display HUD is mounted on an instrument panel INP of the vehicle VCL. As described in detail later, the head-up display HUD projects a virtual image VTI on the windshield WSD (which may as well be referred to a windscreen) of the vehicle VCL. Note that in FIG. 2, the head-up display HUD is installed in front of the driver's seat where the steering wheel WHL is located. Note that the installation position of the head-up display HUD is not limited to this.

When the display panel PNL is a transmissive display panel, the illumination device ILD is located on a rear side of the display panel PNL. Although details thereof will be described later, for the illumination device ILD, a laser backlight is suitable. On the other hand, when the display panel PNL is a reflective display panel, the display panel PNL selectively reflects the illumination light IRL from the illumination device ILD to display images. In this case, the illumination device ILD is located on a front side of the display panel PNL. That is, the illumination device ILD is not a back light, but a front light.

Focusing back to FIG. 1, the concave mirror CMR is a component that reflects the image light IML (containing image light=1, image light IML2 and image light IML3, which will be described later) emitted from the display panel PNL toward the windshield WSD.

The image light IML emitted from the head-up display HUD is projected on the windshield WSD of the vehicle. A user DRV using the head-up display HUD can visually recognize a virtual image VTI in front of the windshield WSD. Note that in the example shown in FIG. 1, the windshield WSD is listed as a projection component on which the image light IML is projected, but it is not limited to this example. In place of the windshield WSD, some other component such as a combiner may as well be used.

It is assumed here that the display panel PNL shown in FIG. 1 is inclined at an angle α1 with respect to the third direction Z. When the angle α1 is small, the virtual image VTI is fixed approximately along the third direction Z. Such a virtual image VTI has a drawback that the sense of depth of the image is small as compared to the background visually recognized through the windshield WSD.

For example, when the virtual image VTI is an image such as of a route guidance service for a vehicle, the user DRV needs to recognize the depth information based on the virtual image VTI fixed approximately along the third direction Z against the background spreading in the horizontal direction (the direction in which the X-Y plane expands). As a result, a natural sense of depth cannot be obtained from the virtual image VTI with respect to the background. In order to obtain a more natural sense of depth from the virtual image VTI, it is necessary to display the virtual image VTI in a position that conforms to the actual background.

FIG. 3 is a diagram showing the positional relationship between the virtual image VTI and the windshield when the angle α1 is small. The virtual image VTI shown in FIG. 3 is an arrow indicating a left turn. However, the virtual image VTI does not exhibit a natural sense of depth because the depth of the virtual image VTI and the background do not match each other. As described above, in order to obtain a more natural sense of depth from the virtual image VTI, it is necessary to display the virtual image VTI in a position that conforms to the actual background.

To solve the above-described drawback, for example, the display panel PNL should be inclined with respect to the third direction Z. More specifically, the display panel PNL should be positioned at an angle greater than the angle α1.

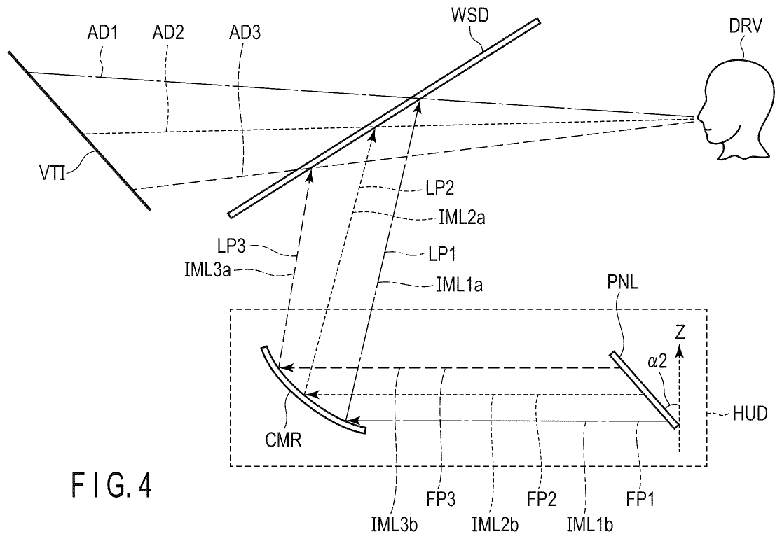

FIG. 4 is a diagram showing a part of the display device of the embodiment. In the head-up display HUD shown in FIG. 4, the illumination device ILD is omitted from illustration. As compared to FIG. 1, the display panel PNL of the head-up display HUD shown in FIG. 4 is inclined by an angle α2, which is greater than the angle α1 (α2>α1), with respect to the third direction Z.

The image light IML1, the image light IML2 and the image light IML3 are the image light components emitted from the areas of the display panel PNL, which correspond to an upper area, a central area and a lower area of the virtual image VTI, respectively. In FIG. 4, the image light components emitted from the lower area, the central area and the upper area of the display panel PNL are the image light components of an upper area, a central area and a lower area of the virtual image VTI, respectively. The areas of the display panel PNL corresponding to the upper area, the central area and the lower area of the virtual image VTI may as well be referred to as a first area, a second area and a third area in this embodiment. In FIG. 4, the first area, the second area and the third area are the lower area, the central area and the upper area of the display panel PNL.

Image light emitted from the lower area of the display panel PNL and reaching the concave mirror CMR is referred to as image light IML1b, and image light reflected by the concave mirror CMR and reaching the windshield WSD is referred to as image light=la. Image light emitted from the central area of the display panel PNL and reaching the concave mirror CMR is referred to as image light IML2b, and image light reflected by the concave mirror CMR and reaching the windshield WSD is referred to as image light IML2a. Image light emitted from the upper area of the display panel PNL and reaching the concave mirror CMR is referred to as image light IML3b, and image light reflected by the concave mirror CMR and reaching the windshield WSD is referred to as image light IML3a. Note that the image light IML1, image light IML2 and image light IML3 may as well be referred to as first image light, second image light and third image light, respectively.

The image light IML1 is reflected by the concave mirror CMR to become the image light in the upper area of the virtual image VTI. The image light IML2 is reflected by the concave mirror CMR to become the image light in the area near the center of the virtual image VTI. The image light IML3 is reflected by the concave mirror CMR to become the image light in the lower area of the virtual image VTI.

In the image light IML1, a distance AD1 to the virtual image VTI and the windshield WSD is a distance obtained by adding to the distance LP1 from the concave mirror CMR to the windshield WSD, a value obtained by multiplying the distance FP1 from the display panel PNL to the concave mirror CMR by a magnification factor mg of the concave mirror CMR. That is, the formula, AD1=LP1+(FP1×mg) (Equation 1) is established. Similarly, the formulas, AD2=LP2+(FP2×mg) (Equation 2) and AD3=LP3+(FP3×mg) (Equation 3) are established.

Here, by increasing the distance AD1 and decreasing the distance AD3, the sense of depth of the virtual image VTI is enhanced. As the angle α2 is larger, the distance AD1 can be made longer and the distance AD3 can be made shorter. To increase the distance AD1, the distance FP1 should be increased. To decrease the distance AD3, the distance FP3 should be decreased.

A main beam of the image light of the display panel PNL is emitted in a direction normal to the display surface. With this configuration, the display panel PNL is inclined more, that is, the angle α2 is made larger, the proportion of the main beam in each of the image light IML1, the image light IML2 and the image light IML3 becomes smaller. This may undesirably cause degradation of optical characteristics such as lowering of brightness, lowering of contrast and deterioration in viewing angle characteristics.

In this head-up display HUD of the embodiment, the image light emitted from the display panel PNL is emitted to the concave mirror CMR via a holographic optical element. The holographic optical element is an optical element that reflects light incident at a specific angle of incidence to a Bragg reflection surface and transmits light incident at an angle of incidence different from the specific angle of incidence. The holographic optical element is also a volume hologram formed not only in the plane direction but also in the depth direction. By utilizing this, the main beam of each image light can be reflected. Thus, it is possible to increase the distance AD1 and decrease the distance AD3 while maintaining the brightness. Therefore, a sense of depth is given to the virtual image VTI.

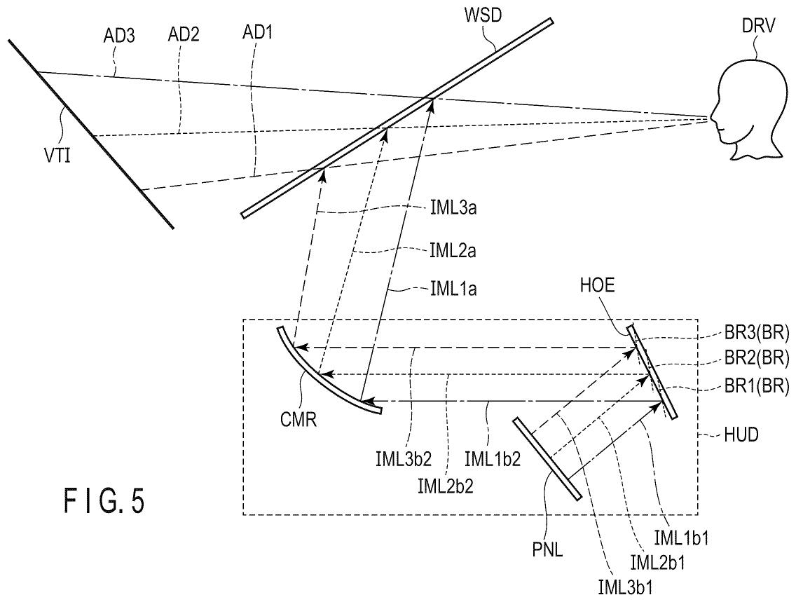

FIG. 5 is a diagram schematically showing a configuration example of the display device of the embodiment. The head-up display HUD shown in FIG. 5 comprises a display panel PNL, a holographic optical element HOE and a concave mirror CMR. The display panel PNL and the holographic optical element HOE are arranged in parallel with each other.

The image light IML1b, the image light IML2b and the image light IML3b emitted from the display panel PNL are reflected by the holographic optical element HOE and reach the concave mirror CMR. The image light IML1b, the image light IML2b and the image light IML3b are emitted from the display surface of the display panel PNL, which correspond to the upper area, the area near the center area and the lower area of the virtual image VTI, respectively.

The holographic optical element HOE reflects light incident at a specific angle of incidence to the Bragg reflection surface BR and transmits light incident at an angle of incidence different from the specific angle of incidence. The Bragg reflection surfaces of the image light IML1b, the image light IML2b, and the image light IMLb are referred to as a Bragg reflection surface BR1, a Bragg reflection surface BR2 and a Bragg reflection surface BR3, respectively.

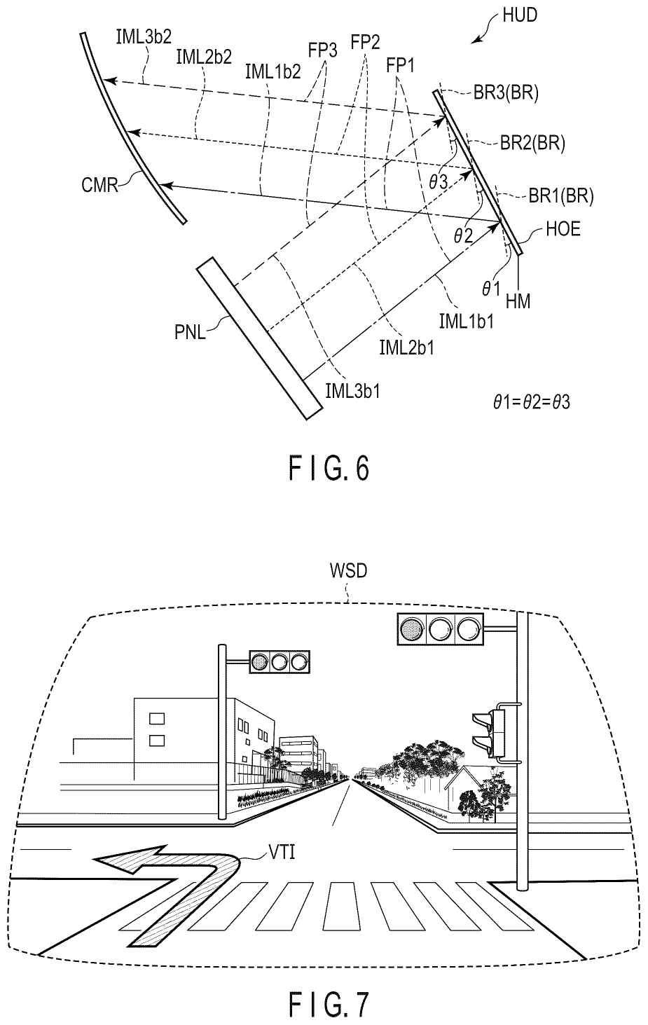

FIG. 6 is an enlarged view of a part of the illustration of FIG. 5. In FIG. 6, only the display panel PNL, the holographic optical element HOE and the concave mirror CMR are shown. The image light components emitted from the display panel PNL and reaching the holographic optical element HOE are referred to as image light IML1b1, image light IML2b1 and image light IML3b1, respectively. The image light components reflected by the holographic optical element HOE and reaching the concave mirror CMR is referred to as image light IML1b2, image light IML2b2 and image light IML3b2, respectively.

The image light IML1b1 and the image light IML1b2 correspond to the image light IML1b. The image light IML2b1 and the image light IML2b2 correspond to the image light IML2b. The image light IML3b1 and the image light IML3b2 correspond to the image light IML3b.

The total of the distances of the image light IML1b1 and the image light IML1b2 corresponds to the distance FP1. The total of the distances of the image light IML2b1 and the image light IML2b2 corresponds to the distance FP2. The total of the distances of the image light IML3b1 and the image light IML3b2 corresponds to the distance FP3.

The angles formed by the plane HM of the holographic optical element HOE and the Bragg reflection surfaces BR (Bragg reflection surface BR1, Bragg reflection surface BR2 and Bragg reflection surface BR3) are referred to as angle θ1, angle θ2 and angle θ3, respectively.

The display panel PNL and the holographic optical element HOE are arranged in parallel with each other. As the holographic optical element HOE, a holographic optical element that reflects at a uniform angle in its plane is used. As a result, the angles θ1, θ2, and θ3 are equal to each other (θ1=θ2=θ3). Note that the angle θ1, angle θ2 and angle θ3 may as well be referred to as a first angle, a second angle, and a third angle, respectively.

By arranging the display panel PNL and the holographic optical element HOE as shown in FIG. 6, the distance FP1 can be made longer and the distance FP3 can be made shorter. The image light IML1b1, the image light IML2b1 and the image light IML3b1 are reflected by the respective Bragg reflection surfaces BR1, the Bragg reflection surface BR2 and the Bragg reflection surface BR3, respectively and emitted as the image light IML1b2, the image light IML2b2 and the image light IML3b2, respectively. With the reflection with the Bragg reflection surfaces, the respective image light can reach the concave mirror CMR while maintaining the brightness of each of the light components.

For the illumination device ILD of this embodiment, a laser backlight comprising a plurality of laser light source elements is preferable. The laser light source elements emit light having a predetermined wavelength as a main wavelength. The holographic optical element HOE has wavelength selectivity. When the wavelength that is selectively reflected by the holographic optical element HOE is set as the main wavelength of the laser light source elements, the light incident on the holographic optical element HOE can be used efficiently. Thus, with use of an illumination device ILD including laser light source elements, it is possible to obtain a virtual image VTI with high brightness.

Further, it is preferable to apply an AR film on the hologram surface of the holographic optical element HOE. With the AR film thus applied, surface reflection of the holographic optical element HOE can be prevented, thereby making it possible to realize good optical characteristics.

FIG. 7 is a diagram showing the positional relationship between the virtual image formed using the holographic optical element of the embodiment and the windshield. As explained in connection with FIGS. 5 and 6, as the distance FP1 is made longer and the distance FP3 is made shorter, the distance AD1 is made longer and the distance AD3 is made shorter. Thus, the virtual image VTI can have a sense of depth along the background. In FIG. 7, the arrow indicating the left turn in the virtual image VTI is an arrow that suits the sense of depth in the road. Thus, in this embodiment, the sense of depth of the virtual image VTI can be increased.

### Configuration Example 1

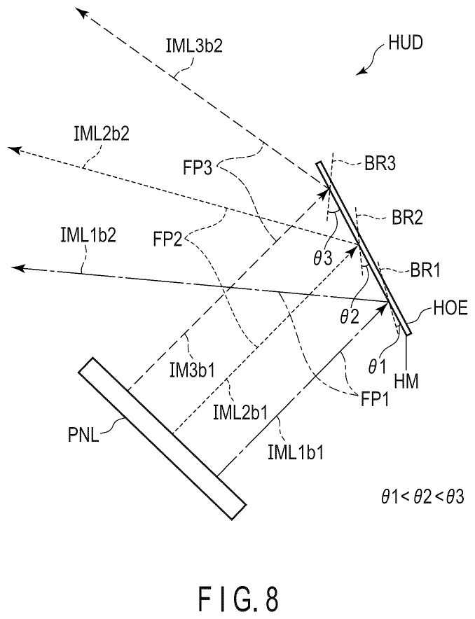

FIG. 8 is a diagram showing another configuration example of the display device in the embodiment. The configuration example shown in FIG. 8 differs from that shown in FIG. 6 in that the display panel and the holographic optical elements are not arranged in parallel with each other, and the angles formed by the plane of the holographic optical element and the Bragg reflection surface are made different from those each other.

In the head-up display HUD shown in FIG. 8, as in the embodiment, the image light components emitted from the lower area, the central area and the lower area of the display panel PNL correspond to the upper area, the area near the center area and the lower area of the virtual image VTI. With respect to the image light IML1b (image light IML1b1 and image light IML1b2), the image light IML2b (image light IML2b1 and image light IML2b2) and the image light IML3b (image light IML3b1 and image light IML3b2), corresponding to the upper area, the area near the center area and the lower area of the virtual image VTI, and the plane HM of the holographic optical elements HOE and the Bragg reflection surfaces BR (the Bragg reflection surface BR1, Bragg reflection surface BR2 and Bragg reflection surface BR3) make the angle θ1, the angle θ2 and the angle θ3, respectively, which are larger in angle in this order (θ1<θ2<θ3). In other words, the angle θ3 is larger than the angle θ1 and the angle θ2, and the angle θ2 is larger than the angle θ1.

In order to make these angles at the Bragg reflection surface BR different from each other, it suffices if the holographic optical elements HOE have the effect of the concave mirror.

By changing the angles θ1, θ2 and θ3, the distance FP1, the distance FP2 and the distance FP3, which are the distances of the optical paths of the image light IML1b, the image light IML2b and the image light IML3b, respectively, can be changed. By making the distance FP1 longer and the distance FP3 shorter, the distance AD1, which is the distance taken between the windshield WSD and the virtual image VTI and corresponds to the image light IML1 can be made longer and the distance AD3 corresponding to the image light IML3 can be made shorter. In this manner, it possible to enhance the sense of depth of the virtual image VTI.

In this configuration example, advantageous effects similar to those of the embodiment can be exhibited.

### Configuration Example 2

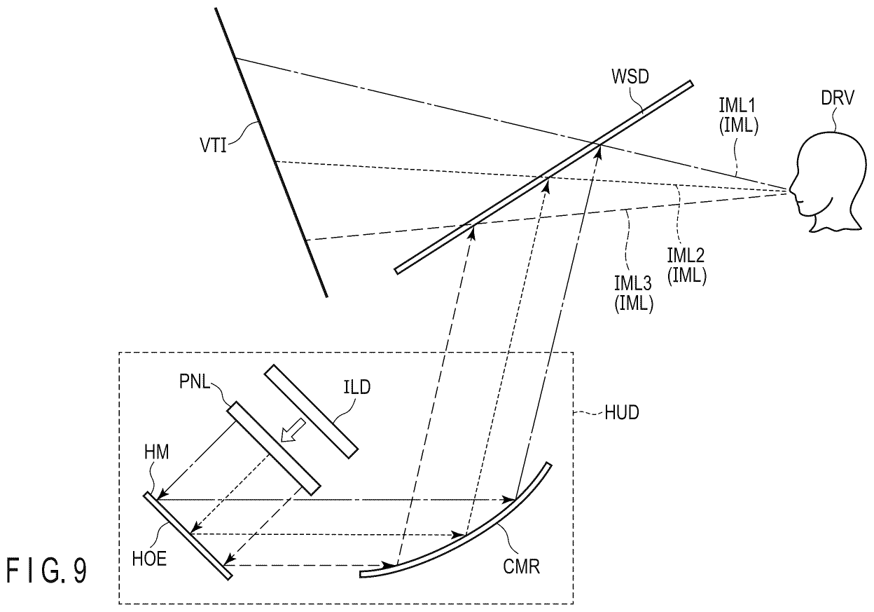

FIG. 9 is a diagram showing another configuration example of the display device in the embodiment. The configuration example shown in FIG. 9 differs from that shown in FIG. 5 in the positional relationship between the display panel and the holographic optical element.

In FIG. 5, the head-up display HUD is positioned between the windshield WSD and the user DRV. On the other hand, in FIG. 9, the head-up display HUD is not positioned between the windshield WSD and the user DRV. In FIG. 9, the windshield WSD is placed between the head-up display HUD and the user DRV.

The holographic optical element HOE shown in FIG. 9 is positioned parallel to the display panel PNL. In FIG. 9, the image light IML1, the image light IML2 and the image light IML3 corresponding to the upper area, the central area and the lower area of the virtual image VTI are emitted from the upper area, the central area and the lower area of the display panel PNL, respectively.

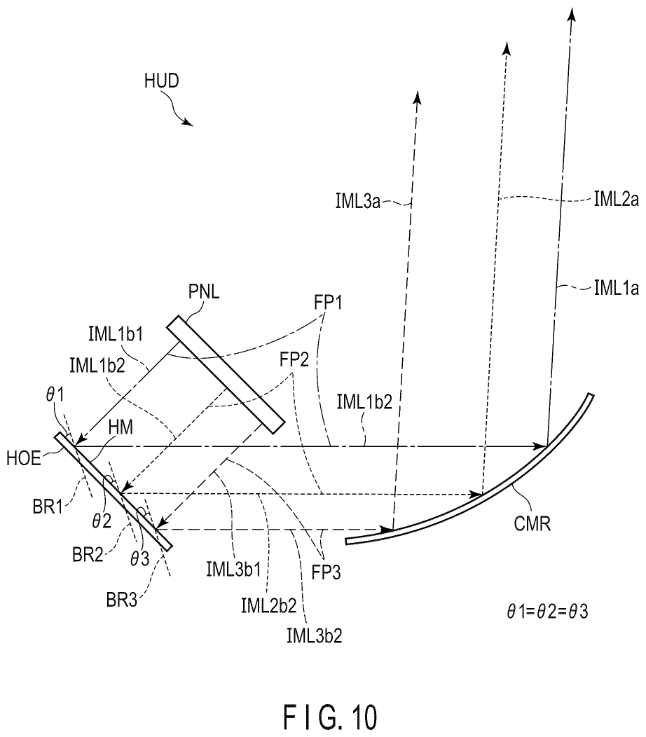

FIG. 10 is an enlarged view of a part of FIG. 9. In the head-up display HUD shown in FIG. 10, as in the case of FIG. 6, with respect to the image light IML1b, the image light IML2b and the image light IML3b emitted from the display panel PNL and the plane HM of the holographic optical element HOE and the Bragg reflection surface BR1, the Bragg reflection surface BR2 and the Bragg reflection surface BR3, make the angle θ1, the angle θ2 and the angle θ3, respectively, which are equal to each other (θ1=θ2=θ3).

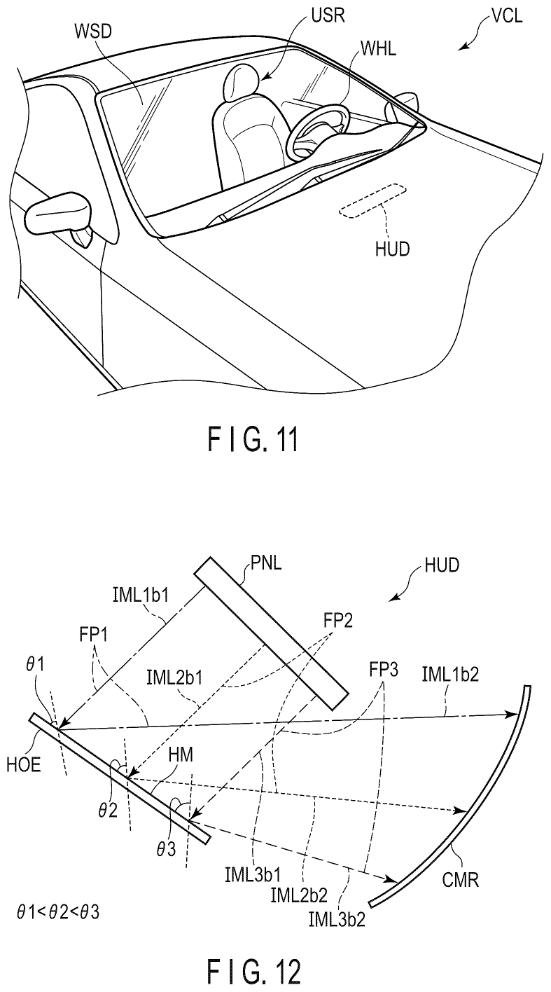

FIG. 11 is a diagram showing the head-up display of this configuration example installed in a vehicle. As explained in FIG. 9, the windshield WSD is placed between the head-up display HUD and the user DRV. In other words, the head-up display HUD shown in FIG. 11 is stored in the area in front of the windshield WSD in the vehicle VCL. By disposing the space occupied by the head-up display HUD not inside the vehicle VCL, but outside the vehicle VCL, it is possible to increase the degree of freedom in the arrangement in the interior of the vehicle VCL.

In this configuration example, advantageous effects similar to those of the embodiment can be exhibited.

### Configuration Example 3

FIG. 12 is a diagram showing another configuration example of the display device in the embodiment. The configuration example shown in FIG. 12 differs from that shown in FIG. 10 in that the angles formed by the planes of the holographic optical elements and the Bragg reflection surfaces are different from each other.

As in the case of FIG. 8, the holographic optical element HOE shown in FIG. 12 is not arranged parallel to the display panel PNL.

In the head-up display HUD shown in FIG. 12, the image light IML1b (image light IML1b1 and image light IML1b2), the image light IML2b (image light IML2b1 and image light IML2b2) and the image light IML3b (image light IML3b1 and image light IML3b2) and the plane HM and the Bragg reflection surface BR of the holographic optical element HOE, make the angle θ1, the angle 62 and the angle θ3, respectively, which are larger in angle in this order (θ1<θ2<θ3).

By changing the angle θ1, the angle θ2 and the angle θ3, the distance FP1, the distance FP2 and the distance FP3, which are the distances of the optical paths of the image light IML1b, the image light IML2b and the image light IML3b, can be changed. By making the distance FP1 longer and the distance FP3 shorter, the distance AD1, which is the distance between the windshield WSD and the virtual image VTI, and corresponds to the image light IML1 can be made longer, and the distance AD3 corresponding to the image light IML3 can be made shorter. Thus, it is possible to enhance the sense of depth of the virtual image VTI.

In this configuration example, advantageous effects similar to those of the embodiment can be exhibited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
an illumination device which emits illumination light;
a display panel which modulates the illumination light and emits image light;
a holographic optical element which reflects the image light emitted from the display panel; and
a concave mirror which reflects the image light reflected by the holographic optical element, wherein
when the image light reflected by the concave mirror enters a projection member, a virtual image is projected, and
the holographic optical element reflects light incident at a specific angle of incidence on a Bragg reflection surface and transmits the light incident at an angle of incidence different from the specific angle of incidence.

2. The display device according to claim 1, wherein
an angle made between a plane of the holographic optical element and the Bragg reflection surface of first image light emitted from a first area of the display panel is a first angle,
an angle made between the plane of the holographic optical element and the Bragg reflection surface of second image light emitted from a second area of the display panel is a second angle,
an angle made between the plane of the holographic optical element and the Bragg reflection surface of third image light emitted from a third area of the display panel is a third angle,
the first area, the second area and the third area of the display panel correspond to an upper area, a central area and a lower area of the virtual image, respectively, and
the first angle, the second angle and the third angle are equal to each other.

3. The display device according to claim 1, wherein
an angle made between a plane of the holographic optical element and the Bragg reflection surface of first image light emitted from a first area of the display panel is a first angle,
an angle made between the plane of the holographic optical element and the Bragg reflection surface of second image light emitted from a second area of the display panel is a second angle,
an angle made between the plane of the holographic optical element and the Bragg reflection surface of third image light emitted from a third area of the display panel is a third angle,
the first area, the second area and the third area of the display panel correspond to an upper area, a central area and a lower area of the virtual image, respectively, and
the first angle, the second angle and the third angle are larger in angle in this order.

4. The display device according to claim 1, wherein
the projection member is a windshield provided in a vehicle,
the image light reflected by the concave mirror enters the windshield, and
as the image light is projected, the virtual image is visually recognized by a user through the windshield.

5. The display device according to claim 4, which is provided between the windshield and the user.

6. The display device according to claim 4, wherein
the windshield is provided between the display device and the user.
